(19) United States
(12) Patent Application Publication
(10) Pub. No.: US 2026/0050989 A1
(43) Pub. Date: Feb. 19, 2026

(54) LARGE LANGUAGE MODELING SYSTEMS AND METHODS FOR GENERATING RESPONSES TO INQUIRIES

(71) Applicant: State Farm Mutual Automobile Insurance Company, Bloomington, IL (US)

(72) Inventors: Haritha Bandi, Frisco, TX (US); Carrie Duong, Allen, TX (US); William Nussbaum, Bloomington, IL (US)

(21) Appl. No.: 18/950,560

(22) Filed: Nov. 18, 2024

Related U.S. Application Data
(60) Provisional application No. 63/667,373, filed on Jul. 3, 2024.

(51) Int. Cl. G06Q 40/08; G06F 40/205; G06Q 10/10

(52) U.S. Cl. CPC G06Q 40/08; G06F 40/205; G06Q 10/10

(57) ABSTRACT

A computer system may be provided. The computer system may be programmed to (i) build the large language model for insurance rate change requests; (ii) receive a current objection inquiry document for a rate change request from an insurance regulator; (iii) electronically parse the current objection inquiry document to identify a first model input including text describing the at least one first objection and the at least one first request for additional information; (iv) enter the first model input into the large language model to generate a first output including an electronic response document for responding to the current objection inquiry for the rate change request; and (v) transmit the electronic response document to the insurance regulator to respond to the at least one first objection and the at least one first request for additional information included in the current objection inquiry document.

### CROSS-REFERENCE TO RELATED APPLICATIONS

This application claims priority to U.S. Provisional Application No. 63/667,373, filed Jul. 3, 2024, the entire contents and disclosure of which are incorporated herein by reference in its entirety.

### FIELD OF THE DISCLOSURE

The present disclosure relates generally to generating responses to inquiries, and more particularly, to a network-based system and method that uses large language models to receive, review, and respond to objection and inquiry documents.

### BACKGROUND

Analysis of large systems may require significant amounts of data and time to determine if there are issues and determine how solutions to those issues should be implemented. Furthermore, some analysis systems may have significant numbers of inputs and variables that affect the ease and time for analysis. Large language models (LLM) may be used for analysis of many systems. However, they are not a one size fits all solution.

Many systems have special features that may or may not be handled by the standard large language model. One challenge in the insurance industry is in the area of responding to inquiries relating to rate changes. A Property and Casualty (P&C) actuarial department of an insurance company may submit a significant number of rate change requests in a given year. They may do this year after year. These rate change requests may be submitted to different departments of insurance within different states within the United States. Most of these rate change requests receive multiple rounds of objections or inquiries from those departments of insurance. Each round of objections typically takes about 10 person hours on average to respond to. This includes the work of actuarial analysts to draft the responses and the managers to review and approve the responses before they are submitted. For many larger insurance companies, this means the equivalent of approximately seven (7) full-time employees working every year writing these responses. The process of responding is manual in nature where the actuarial analysts may leverage multiple sources of information and consult with other analysts in order to come up with objection response for the departments of insurance.

The ability to use large language models (LLMs) and generative AI (artificial intelligence) to address the challenges of generating and submitting responses to inquiries from the department of insurance in response to rate change submissions is needed. Conventional large language models and generative AI tools do not currently address these challenges. Conventional techniques may have additional ineffectiveness, inefficiencies, encumbrances, and/or other drawbacks, as well.

### BRIEF SUMMARY

The present embodiments may relate to, inter alia, a system analysis tool that may customize a large language model (LLM) to generate a response to a current objection inquiry document using artificial intelligence (AI) tools. Further, the present embodiments may relate to building the large language model for insurance rate change requests. The computer systems and computer-implemented methods described herein may provide for receiving a current objection inquiry document for a rate change request from an insurance regulator. The current objection inquiry document may include at least one first objection to the rate change request and at least one first request for additional information. The computer systems and computer-implemented methods described herein may also provide for electronically parsing the current objection inquiry document to identify a first model input including text describing the at least one first objection and the at least one first request for additional information. The computer systems and computer-implemented methods described herein may further provide for entering the first model input into the large language model to generate a first output including an electronic response document for responding to the current objection inquiry for the rate change request. In addition, the computer systems and computer-implemented methods described herein may provide for transmitting the electronic response document to the insurance regulator to respond to the at least one first objection and the at least one first request for additional information included in the current objection inquiry document.

In one aspect, a computer system for generating a response to a current objection inquiry document using artificial intelligence (AI) tools is provided. The computer system includes at least one processor, at least one memory device in communication with the at least one processor, and AI tools including a large language model. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device, and further in communication with AI tools including a large language model. The at least one processor may be configured to: (1) build the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers; (2) receive a current objection inquiry document for a rate change request from an insurance regulator, the current objection inquiry document including (i) at least one first objection to the rate change request and (ii) at least one first request for additional information; (3) electronically parse the current objection inquiry document to identify a first model input including text describing the at least one first objection and the at least one first request for additional information; (4) enter the first model input into the large language model to generate a first output including an electronic response document for responding to the current objection inquiry for the rate change request; and (5) transmit the electronic response document to the insurance regulator to respond to the at least one first objection and the at least one first request for additional information included in the current objection inquiry document. The computer system may include additional, less, or alternate functionality, including that discussed elsewhere herein.

In another aspect, a computer-implemented method for building, simulating, and/or validating a machine learning model may be provided. The computer-implemented method may be performed by a computer device including at least one processor in communication with at least one memory device. The method may include: (1) building the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers; (2) receiving a current objection inquiry document for a rate change request from an insurance regulator, the current objection inquiry document including (i) at least one first objection to the rate change request and (ii) at least one first request for additional information; (3) electronically parsing the current objection inquiry document to identify a first model input including text describing the at least one first objection and the at least one first request for additional information; (4) entering the first model input into the large language model to generate a first output including an electronic response document for responding to the current objection inquiry for the rate change request; and (5) transmitting the electronic response document to the insurance regulator to respond to the at least one first objection and the at least one first request for additional information included in the current objection inquiry document. The computer-implemented method may include additional, less, or alternate actions, including those discussed elsewhere herein.

In a further aspect, at least one non-transitory computer-readable media having computer-executable instructions embodied thereon may be provided. When executed by a computing device including at least one processor in communication with at least one memory device, the computer-executable instructions may cause the at least one processor to: (1) build the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers; (2) receive a current objection inquiry document for a rate change request from an insurance regulator, the current objection inquiry document including (i) at least one first objection to the rate change request and (ii) at least one first request for additional information; (3) electronically parse the current objection inquiry document to identify a first model input including text describing the at least one first objection and the at least one first request for additional information; (4) enter the first model input into the large language model to generate a first output including an electronic response document for responding to the current objection inquiry for the rate change request; and (5) transmit the electronic response document to the insurance regulator to respond to the at least one first objection and the at least one first request for additional information included in the current objection inquiry document. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements discussed herein certain exemplary embodiments. It should be understood, however, that the present embodiments are not limited to the precise arrangements and/or instrumentalities shown herein.

FIG. 1 illustrates a flowchart of an exemplary process for receiving and responding to one or more objections to a pricing model, in accordance with one embodiment of the present disclosure.

FIG. 2 illustrates a flow diagram of an exemplary process for receiving and responding to one or more objections to a pricing model, in accordance with one embodiment of the present disclosure.

FIG. 3 illustrates a diagram of an exemplary response document created by the process shown in FIG. 2.

FIG. 4 illustrates a flow diagram of an exemplary process for receiving and responding to one or more objections, in accordance with one embodiment of the present disclosure.

FIG. 5 illustrates a flow diagram of an exemplary process for receiving and responding to an objection inquiry document, in accordance with one embodiment of the present disclosure.

FIG. 6 illustrates an exemplary computer system for performing the exemplary processes shown in FIGS. 2, 4, and 5.

FIG. 7 is a schematic diagram of an exemplary objection analysis and response (OAR) server that is shown in FIG. 6 and that may be used with the system shown in FIG. 6.

FIG. 8 illustrates an exemplary configuration of a user computer device, in accordance with one embodiment of the present disclosure.

FIG. 9 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present disclosure relates generally to, inter alia, automatically generating electronic responses to inquiries, and more particularly, to a network-based system and method that uses large language models to receive, review, and respond to objection and inquiry documents. In one exemplary embodiment, the process may be performed by an objection analysis and response (OAR) computer system. In the exemplary embodiment, the OAR computer system may be in communication with one or more client devices, and/or one or more third-party data sources.

As described below in further detail, the OAR computer system includes one or more large language models (LLM), such as GPT (Generative Pre-trained Transformers) models, and one or more supplemental models that are configured to curate data from internal and external sources to send to the one or more GPT models. The one or more supplemental models are configured to leverage the one or more GPT models for their wide range of capabilities and based on the data processed by the one or more supplemental models.

In the exemplary embodiment, the OAR computer system may be configured to use the one of more GPT models, one or more third-party data sources, and a prompt engineering system to actively analyze and generate responses to inquiries.

In the exemplary embodiment, the OAR computer system may be configured to generate responses to inquiries, and more particularly, the OAR system may include a network-based system and method that uses large language models to receive, review, and respond to objection and inquiry documents.

In the exemplary embodiment, the OAR computer system receives an objection inquiry document. In the exemplary embodiment, the objection inquiry document may include a plurality of objections and a plurality of requests for information. In some embodiments, the objection inquiry document may only include objections or requests for information. In the exemplary embodiment, the objection inquiry document is in response to having a document reviewed by a reviewing institution, which results in the objection inquiry document being created.

In the exemplary embodiment, the OAR computer system parses the objection inquiry document. In these embodiments, the OAR computer system uses one or more natural language processing (NLP) systems to parse the objection inquiry document.

In one example embodiment, the OAR computer system uses NLP to analyze the objection inquiry document, such as for a rate change request from an insurance regulator. In this embodiment, the objection inquiry document may include at least (i) objections to the rate change request and (ii) requests for additional information. Based upon the NLP processing, the OAR computer system identifies the party sending the objection inquiry document, determines the date of the objection inquiry document, and determines the due date to submit a response to the objection inquiry document. In some further embodiments, the OAR computer system builds a calendar entry including the due date to submit the response and the party to who the response is to be submitted to.

In the exemplary embodiment, the OAR computer system identifies an objection, such as objection #O1 (Objection 1), using NLP. The NLP is used to identify keywords in the identified objection. The OAR computer system generates a search query for the objection using the keywords from the objection. In some embodiments, the search query is generated by a prompt engineering system. The OAR computer system executes the search query for the objection in one or more trained LLMs. The execution of the search query generates a sub-response for the objection. The sub-response may include text and/or graphics to respond to the objection.

The OAR computer system determines if there are more objections in the objection inquiry document that have not yet had sub-responses generated. If there are more objections to be responded to, the OAR computer system returns to the Step to identify the next objection in the objection inquiry document. The OAR computer system continues this loop until all of the objections in the objection inquiry document have been responded to. If there are no additional objections, then the OAR computer system generates transitional language for between the sub-responses. In some embodiments, the OAR computer system generates transitional language after each sub-response.

In the exemplary embodiment, the OAR computer system identifies a request for information, such as request for info #I1, using NLP. The NLP is used to identify keywords in the identified request for information. The OAR computer system generates a search query for the request for information using the keywords from the request for information. In some embodiments, the search query is generated by the prompt engineering system. The OAR computer system executes the search query for the request for information in one or more trained LLMs. The execution of the search query generates a sub-response for the request for information. The sub-response may include text and/or graphics to respond to the request for information.

The OAR computer system determines if there are more requests for information in the objection inquiry document that have not yet had sub-responses generated. If there are more requests for information to be responded to, the OAR computer system returns to the Step to identify the next request for information in the objection inquiry document. The OAR computer system continues this loop until all of the requests for information in the objection inquiry document have been responded to. If there are no additional requests for information, then the OAR computer system generates transitional language for between the sub-responses. In some embodiments, the OAR computer system generates transitional language after each sub-response.

While the above describes a system for analyzing an objection document, one having skill in the art would understand that the systems and methods described herein may also be used for other documents and/or processes that require responses.

### Exemplary Objection Response Process

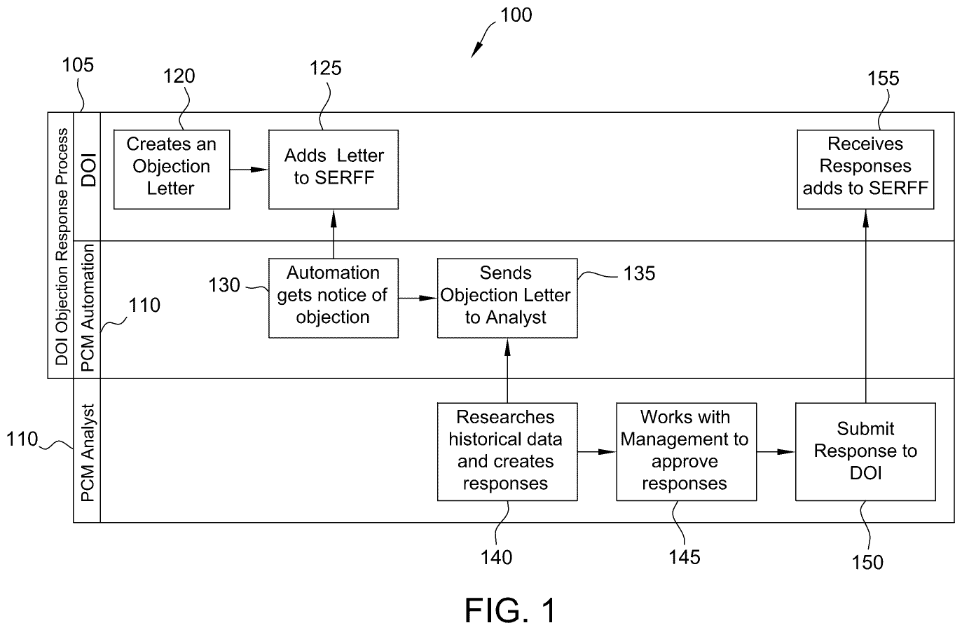

FIG. 1 illustrates a flowchart of an exemplary process 100 for receiving and responding to one or more objections to a pricing model, in accordance with one embodiment of the present disclosure. In process 100, a review institution 105 reviews one or more items, such as, but not limited to, a pricing model discussed above. In one embodiment, the review institution 105 may be the department of Insurance (DOI). Other review institutions 105 may be substituted to review other items and used with the systems and processes described herein.

In the exemplary embodiment, the review institution 105 creates 120 an objection to the item being reviewed. The review institution 105 provides 125 on a file repository, such as System for Electronic Rate and Form Filing (SERFF), the objection to the item being reviewed.

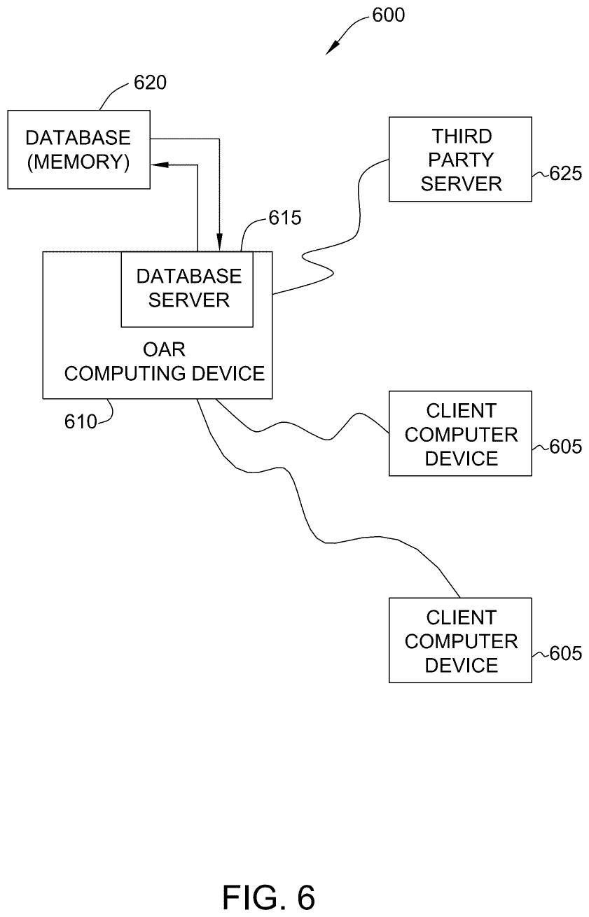

In the exemplary embodiment, an automation system 110, such as the OAR computer system 610 (shown in FIG. 6), receives 130 a notification that the objection has been uploaded to the file repository. In some embodiments, the notification is received 130 from the file repository. In other embodiments, the notification is received from the review institution 105.

In the exemplary embodiment, the automation system 110 may transmit 135 the objection to one or more analysts 115 for review and response. In some embodiments, the automation system 110 retrieves the objection from the file repository. In other embodiments, the automation system 110 provides 135 the one or more analysts 115 with a link to retrieve the objection. In some embodiments, the automation system 110 executes the OAR computer system 610 (as described below in greater detail), to output a response to the objection.

In the exemplary embodiment, the one or more analysts 115 may review the objection, which contains a plurality of sub-objections. Then the one or more analysts 115 research 140 historical data, such as past responses, to create sub-responses to the sub-objections. The analysts may utilize the OAR computer system 610 to automatically generate these responses. The one or more analysts 115 work 145 with management to approve the sub-responses and to generate a response of the sub-responses. Then the one or more analysts 115 submit 150 the approved response to the reviewing institution 105. The reviewing institution 105 receives 155 the response. In some embodiments, the one or more analysts 115 upload the responses to the file repository.

### Exemplary Objection Response Process

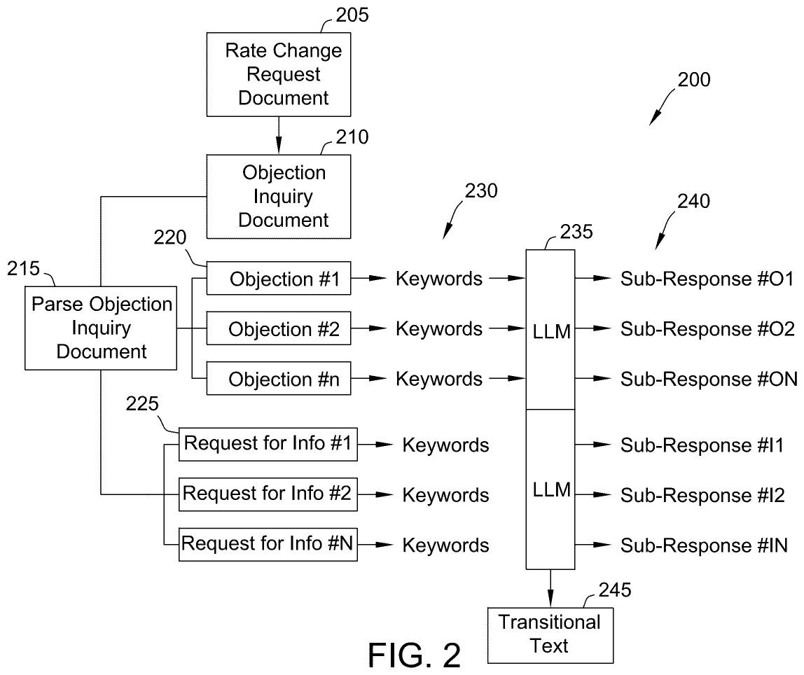

FIG. 2 illustrates a flow diagram of an exemplary process 200 for receiving and responding to one or more objections to a pricing model, in accordance with one embodiment of the present disclosure. In the exemplary embodiment, the functionality or operations of process 200 may be performed by the OAR computer system 610 (shown in FIG. 6). In the exemplary embodiment, the OAR computer system 610 may perform one or more steps of the automation system 110 and the one or more analysts 115 in process 100 (all shown in FIG. 1).

In the exemplary embodiment, a rate change request document 205 is submitted to a reviewing institution 105 (shown in FIG. 1). The reviewing institution 105 returns an objection inquiry document 210, which is received/retrieved by the OAR computer system 610.

In the exemplary embodiment, the OAR computer system 610 parses 215 the objection inquiry document 210 into individual objections 220 (also known as sub-objections) and requests for information 225. The OAR computer system 510 uses natural language processing to determine keywords 230 in both the individual objections 220 and the requests for information 225. The OAR computer system 610 passes the keywords 230 to one or more LLMs 235 to generate responses 240 to the objections 220 and the requests for information 225. In at least one embodiment, the OAR computer system 610 may also have the LLMs 235 craft transitional text 245 that is placed in the responding document to transition between responses 240. In the exemplary embodiment, the OAR computer system 610 compiles the responses 240 and the transitional text 245 to create a response to the objection inquiry document 210.

### Exemplary Response Document

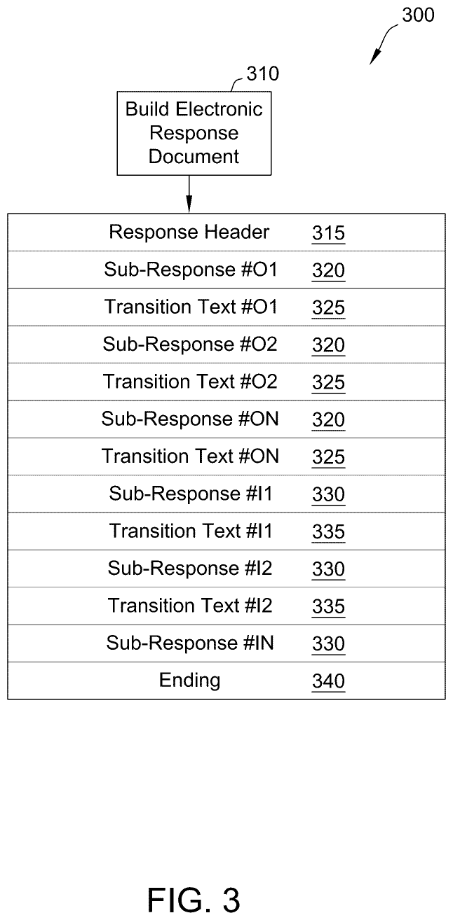

FIG. 3 illustrates a diagram of an exemplary response document 300 created by the process 200 (shown in FIG. 2). In the exemplary embodiment, the response document 300 is built 310 by the OAR computer system 610 (shown in FIG. 6) in response to the objection inquiry document 210 (shown in FIG. 2).

In the exemplary embodiment, the response document 300 includes a response header 315 generated by one or more LLMs 235 (shown in FIG. 2) to respond to the objection inquiry document 210. The response document 300 may also include a plurality of objection sub-responses 320 in response to individual objections 220 (shown in FIG. 2). After each objection sub-response 320, the OAR computer system 610 may include transition text 325 to transition to the next objection sub-response 320.

After all of the sub-responses 320, the response document 300 includes a plurality of information sub-responses 330 for each request for information 225 (shown in FIG. 2). After each information sub-response 330, the OAR computer system 610 includes transition text 335 to transition to the next information sub-response 330. At the end of the response document 300 there is an ending 340 or conclusion.

In the exemplary embodiment, the response document 300 is generated by one or more LLMs 635.

While the above describes a system for analyzing an objection document 210, one having skill in the art would understand that the systems and methods described herein may also be used for other documents and/or processes that require responses.

### Exemplary Objection Response Process

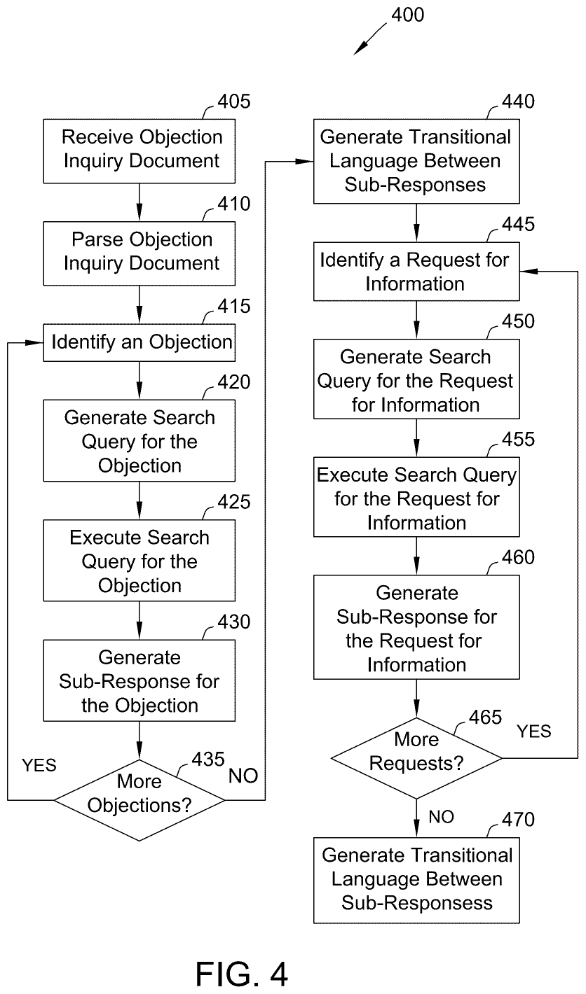

FIG. 4 illustrates a flow diagram of an exemplary process 400 for receiving and responding to one or more objections, in accordance with one embodiment of the present disclosure. In the exemplary embodiment, the functionality or operations of process 400 may be performed by the OAR computer system 610 (shown in FIG. 6) in communication with one or more LLMs 235 (shown in FIG. 2), one or more third-party servers 625 (shown in FIG. 6), and/or a prompt engineering system.

In the exemplary embodiment, the OAR computer system 610 receives 405 an objection inquiry document 210 (shown in FIG. 2). In the exemplary embodiment, the objection inquiry document 210 includes a plurality of objections 220 and a plurality of requests for information 225 (all shown in FIG. 2). In some embodiments, the objection inquiry document 210 only includes objections 220 and/or requests for information 225. In the exemplary embodiment, the objection inquiry document 210 is in response to having a document reviewed by a reviewing institution 105 (shown in FIG. 1).

In the exemplary embodiment, the OAR computer system 610 parses 410 the objection inquiry document 210. In these embodiments, the OAR computer system 610 uses one or more natural language processing (NLP) systems to parse 410 the objection inquiry document 210.

In one example embodiment, the OAR computer system 610 uses NLP to analyze the objection inquiry document 210, such as for a rate change request from an insurance regulator. In this embodiment, the objection inquiry document 210 may include at least one of (i) objections to the rate change request and (ii) requests for additional information. Based upon the NLP processing, the OAR computer system 610 identifies the party sending the objection inquiry document 210, determines the date of the objection inquiry document 210, and determines the due date to submit a response 300 (shown in FIG. 3) to the objection inquiry document 610. In some further embodiments, the OAR computer system 610 builds a calendar entry including the due date to submit the response 300 and the party to who the response 300 is to be submitted to.

In the exemplary embodiment, the OAR computer system 110 identifies 415 an objection 220, such as objection #O1 (Objection 1), using NLP. The NLP is used to identify keywords 230 (shown in FIG. 2) in the identified objection 220. The OAR computer system 610 generates 420 a search query for the objection 220 using the keywords 230 from the objection 220. In some embodiments, the search query is generated by a prompt engineering system. The OAR computer system 610 executes 425 the search query for the objection 220 in one or more trained LLMs 235 (shown in FIG. 2). The execution 425 of the search query generates 430 a sub-response 240 (shown in FIG. 2) for the objection 220. The sub-response 240 may include text and/or graphics to respond to the objection 220.

The OAR computer system 610 determines 435 if there are more objections 220 in the objection inquiry document 210 that have not yet had sub-responses 240 generated 430. If there are more objections 220 to be responded to, the OAR computer system 610 returns to Step 415 to identify 415 the next objection 220 in the objection inquiry document 210. The OAR computer system 610 continues this loop until all of the objections 220 in the objection inquiry document 210 have been responded to. If there are no additional objections 220, then the OAR computer system 610 generates 440 transitional language 245 (shown in FIG. 2) for transitioning between the sub-responses 240 within the response document. In some embodiments, the OAR computer system 610 generates 440 transitional language 245 after each sub-response 240.

In the exemplary embodiment, the OAR computer system 610 identifies 445 a request for information 225, such as request for info #I1, using NLP. The NLP is used to identify keywords 230 in the identified request for information 225. The OAR computer system 610 generates 450 a search query for the request for information 225 using the keywords 230 from the request for information 225. In some embodiments, the search query is generated by the prompt engineering system. The OAR computer system 610 executes 455 the search query for the request for information 225 in one or more trained LLMs 235. The execution 455 of the search query generates 460 a sub-response 240 for the request for information 225. The sub-response 240 may include text and/or graphics to respond to the request for information 225.

The OAR computer system 610 determines 465 if there are more requests for information 225 in the objection inquiry document 210 that have not yet had sub-responses 240 generated 460. If there are more requests for information 225 to be responded to, the OAR computer system 610 returns to Step 445 to identify 445 the next request for information 225 in the objection inquiry document 210. The OAR computer system 610 continues this loop until all of the requests for information 225 in the objection inquiry document 210 have been responded to. If there are no additional requests for information 225, then the OAR computer system 610 generates 470 transitional language 245 for transitioning between the sub-responses 240 within the response document. In some embodiments, the OAR computer system 610 generates 470 transitional language 245 after each sub-response 240.

While the above describes a system for analyzing an objection document 210, one having skill in the art would understand that the systems and methods described herein may also be used for other documents and/or processes that require responses.

### Exemplary Response Generation Process

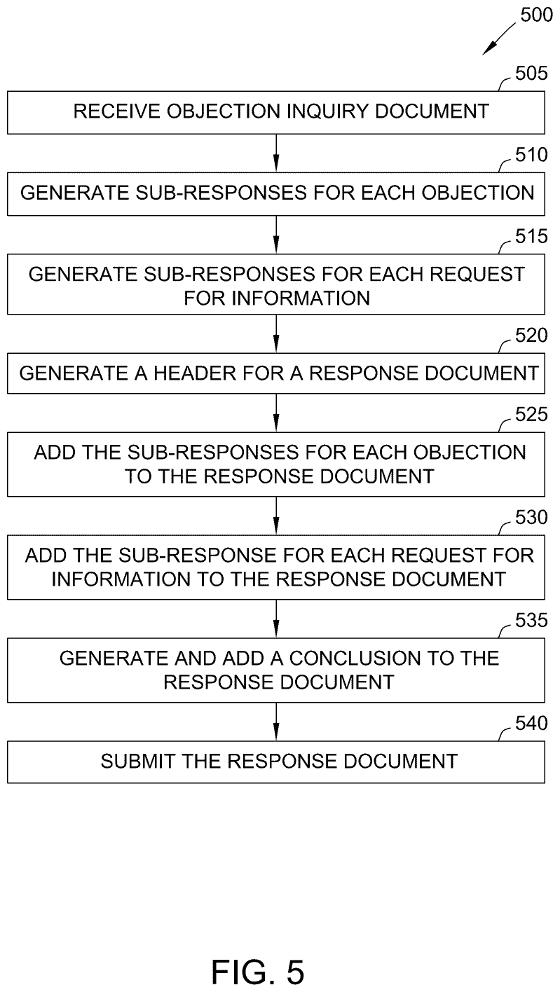

FIG. 5 illustrates a flow diagram of an exemplary process 500 for receiving and responding to an objection inquiry document 210 (shown in FIG. 2), in accordance with one embodiment of the present disclosure. In the exemplary embodiment, the functionality or operations of process 500 may be performed by the OAR computer system 610 (shown in FIG. 6) in communication with one or more LLMs 235 (shown in FIG. 2), one or more third-party servers 625 (shown in FIG. 6), and/or a prompt engineering system.

In the exemplary embodiment, the OAR computer system 610 receives 505 an objection inquiry document 210. In the exemplary embodiment, the objection inquiry document 210 includes a plurality of objections 220 and a plurality of requests for information 225 (both shown in FIG. 2). In some embodiments, the objection inquiry document 210 may only include objections 220 and/or requests for information 225. In the exemplary embodiment, the objection inquiry document 210 is in response to having a document reviewed by a reviewing institution 105 (shown in FIG. 1).

In the exemplary embodiment, the OAR computer system 610 generates 510 sub-responses 240 (shown in FIG. 2) for each objection 220 in the objection inquiry document 210. In at least one embodiment, the OAR computer system 610 performs one or more of the steps of process 400 (shown in FIG. 4) to generate 510 the sub-responses 240 for each objection 220 in the objection inquiry document 210.

In the exemplary embodiment, the OAR computer system 610 generates 515 sub-responses 240 (shown in FIG. 2) for each request for information 225 in the objection inquiry document 210. In at least one embodiment, the OAR computer system 610 performs one or more of the steps of process 400 to generate 515 the sub-responses 240 for each request for information 225 in the objection inquiry document 210.

In the exemplary embodiment, the OAR computer device 610 generates 520 a response header 315 (shown in FIG. 3) for a response document 300 (shown in FIG. 3). In some embodiments, the OAR computer device 610 generates 520 the response header 315 including text indicating the party who the electronic response document 300 is to be addressed to, the date the electronic response document 300 is to be sent, and the due date for submitting the electronic response document 300.

In the exemplary embodiment, the OAR computer device 610 adds 525 the sub-responses 240 for each of the objections 820 to the objection inquiry document 210. In this embodiment, the OAR computer system 610 builds a first portion of the electronic response document 300 including the text and/or graphics of sub-responses 240 to objections 220 along with the transitional text 245 (shown in FIG. 2) for between each of sub-responses 240.

In the exemplary embodiment, the OAR computer system 610 adds 530 the sub-responses 240 for each of the requests for information 225 to the objection inquiry document 210. In this embodiment, the OAR computer system 610 builds a second portion of the electronic response document 300 including the text and/or graphics of sub-responses 240 to requests for information 225 along with the transitional text 245 (shown in FIG. 2) for between each of sub-responses 240.

In the exemplary embodiment, the OAR computer system 610 generates and adds 535 a conclusion 340 (shown in FIG. 3) to the response document 300.

In the exemplary embodiment, the OAR computer system 610 submits 540 the response document 300 to the reviewing institution 705.

In some embodiments, an additional objection inquiry document 210 or a decision document may be sent to an insurance provider by the insurance regulator (acting as the reviewing institution 105) in response to sending the electronic response document 300. The additional objection inquiry document 210 or decision document may include new objections 220, new requests for information 225, and/or a renewal of the previous objections 220 and/or requests for information 225. In other cases, the decision document may include an approval of the rate change request submitted by the insurance provider in view of the submitted electronic response document 300. In that case, no further response may be needed to the decision document. However, in those cases where the additional objection inquiry document 210 or decision document raises new objections 220 and/or request for information 225, and/or renews any of the previous objections 220 and/or requests for information 225, the system 600 (shown in FIG. 6) is configured to repeat the NLP process and generate a new response 300 to the additional objection inquiry document 210 or decision document.

In the exemplary embodiment, the OAR computer system 610 automatically tracks the progress of the initial rate change request submitted by the insurance provider; the objection inquiry document 210 issued by the insurance regulator 105; the electronic response document 300 submitted in response to the objection inquiry document 210; any additional objection inquiry document 210 or decision document issued by the insurance regulator in response to the electronic response document 300; and the second electronic response document 300 submitted by the insurance provider in response to the addition objection inquiry document 810 or decision document. In some further embodiments, the OAR computer system 610 causes the progress of each document to be displayed on a dashboard for the user to track and follow up as needed.

While the above describes systems and methods of computer systems analyzing and generating data, one having skill in the art would understand that that generated data may be reviewed by one or more individuals for approval and/or rating. Furthermore, in many embodiments, the systems require one of more authorized users to sign-off on and approve the response documents before being submitted.

### Exemplary Computer System

FIG. 6 illustrates an exemplary computer system 600 for performing the process 200 (shown in FIG. 2). In the exemplary embodiment, the system 600 may be used for receiving and responding to one or more objections.

As described below in more detail, the objection analysis and response (OAR) computer device 610 may be programmed for receiving and responding to one or more objections. In addition, the OAR computer system 610 may be programmed to coordinate the communication and execute of large language models (LLM). In some embodiments, the OAR computer system 610 may be programmed to (1) build the large language model 235 (shown in FIG. 2) for insurance rate change requests using at least the following input documents: (i) a plurality of historical rate change requests from an insurance provider including a description of each historical rate change request, (ii) a plurality of historical objection inquiries 210 (shown in FIG. 2) from insurance regulators 105 (shown in FIG. 1) to the plurality of historical rate change requests including one or more different objections 220 and/or requests for information 225 (both shown in FIG. 2) relating to each of the historical rate change requests, (iii) a plurality of historical responses 300 (shown in FIG. 3) from the insurance providers to the plurality of historical objection inquiries 210 including responses 300 to each of the one or more objections 220 and/or requests for information 225, and (iv) a plurality of historical decisions from the insurance regulators 105 responding to the plurality of historical responses 300 from the insurance providers; (2) receive a current objection inquiry document 210 for a rate change request from an insurance regulator 105, the current objection inquiry document 210 including (i) at least one first objection 220 to the rate change request and (ii) at least one first request for additional information 225; (3) electronically parse 215 (shown in FIG. 2) the current objection inquiry document 210 to identify a first model input 230 (shown in FIG. 2) including text describing the at least one first objection 220 and the at least one first request for additional information 225; (4) enter the first model input 230 into the large language model 235 to generate a first output 240 including an electronic response document 300 for responding to the current objection inquiry 210 for the rate change request; and (5) transmit the electronic response document 300 to the insurance regulator 105 to respond to the at least one first objection 220 and the at least one first request for additional information 225 included in the current objection inquiry document 210.

In the exemplary embodiment, client devices 605 may be computers or computing devices that include a web browser or a software application, which enables client devices 605 to communicate with OAR computer system 610 using the Internet, a local area network (LAN), or a wide area network (WAN). In some embodiments, the client devices 605 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 605 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, the OAR computer system 610 (also known as OAR server 610) may be a computer that includes a web browser or a software application, which enables OAR computer system 610 to communicate with client devices 605 using the Internet, a local area network (LAN), or a wide area network (WAN). In some embodiments, the OAR computer system 610 may be communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. OAR computer system 610 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In additional embodiments, the OAR computer system 610 may also be in communication with at prompt engineering system (not shown) that receives natural language text and then converts that text into structured text for interpretation and comprehension by generative AI (artificial intelligence). In some embodiments, the prompt engineering system may be internal to the OAR computer system 610. In other embodiments the prompt engineering system may be separate from the OAR computer system 610. In at least one embodiment, the prompt engineering system acts as an interface between the OAR computer system 610 and one or more client device 605 associated with one or more users.

In the exemplary embodiment, the OAR computer system 610 may be configured to use the LLMs 235, the third-party servers 625, and the prompt engineering system to actively receive, review, and respond to one or more objections 220 as described in FIGS. 1-5.

A database server 615 may be communicatively coupled to a database 620 that stores data. In one embodiment, the database 620 may be a database that includes one or more large language models 235 and/or response information. In some embodiments, the database 620 is stored remotely from the OAR computer system 610. In some embodiments, the database 620 is decentralized. In the exemplary embodiment, a person may access the database 620 via the client devices 605 by logging onto OAR computer system 610.

Third-party servers 625 may be any third-party server that OAR computer system 610 is in communication with that provides additional functionality and/or information to OAR computer system 610. For example, third-party server 625 may be an external data source.

In the exemplary embodiment, third-party servers 625 may be computers that include a web browser or a software application, which enables third-party servers 625 to communicate with OAR computer system 610 using the Internet, a local area network (LAN), or a wide area network (WAN). In some embodiments, the third-party server 625 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 625 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

### Exemplary Server Device

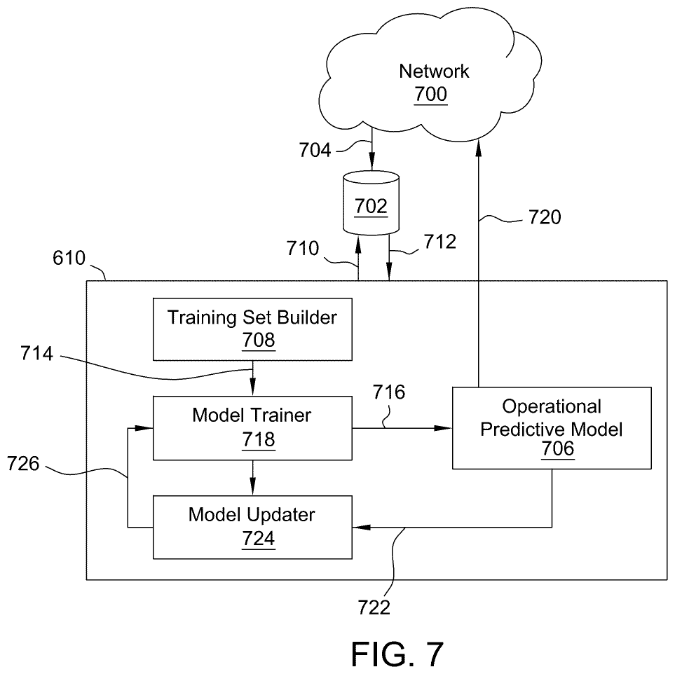

FIG. 7 is a schematic diagram of an exemplary objection analysis and response (OAR) server 610 (shown in FIG. 6), that may be used with the systems 600 (shown in FIG. 6). OAR server 610 may communicate with other components of system 600, such as third-party servers 625, client computer devices 605 (both shown in FIG. 6), LLMs 235 (shown in FIG. 2), and/or a prompt engineering system, via a network 700.

OAR server 610 may include and/or be in communication with a database 702 that stores data 704, such as database 610 (shown in FIG. 6), stored records generated by OAR server 610, and/or any other relevant data s described herein. Data 704 received from network 700 may be stored in database 702. OAR server 610 may configured to use data 704 to generate an operational large language model module 706 for controlling operations of MTA server 310 (e.g., in accessing third-party databases via a digital portal), predicting outcomes of claims, generating action recommendations in response to operational requests, and the like.

In exemplary embodiments, OAR server 610 may include a training set builder module 708 configured to submit one or more queries 710 to database 702 to retrieve subsets 712 of data 704, and to use those subsets 712 to build training data sets 714 for generating operational large language model 706. For example, query 710 may be configured to retrieve certain fields from data 704 for a specific product, a specific category, and/or any other division of factors desired by the user and/or for compliance, such as with a regulating entity 105 (shown in FIG. 1).

In various embodiments, training set builder module 708 may be configured to derive training data sets 714 from retrieved subsets 712. Each training data set 714 corresponds to a historical data 704 (“historical” in this context means completed in the past, as opposed to completed in real-time with respect to the time of retrieval). Each training data set 714 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 714 may be generated from data fields in subset 712 corresponding to historical data 704. In other words, a trained machine learning model 716 produced by a model trainer module 718 for use by operational predictive model module 706 is trained to make predictions based upon input values that can be generated from the data fields in data 704. Values in the model input data fields may include values copied directly from values in a corresponding data field in the retrieved subset 712, and/or values generated by modifying, combining, or otherwise operating upon values in one or more data fields in the retrieved subset 712. The use of such data fields as model input data fields facilitates the machine learning model in weighing these factors directly.

After training set builder module 708 generates training data sets 714, training set builder module 708 passes the training data sets 714 to model trainer module 718. In certain embodiments, model trainer module 718 may be configured to apply the model input data fields of each training data set 714 as inputs to one or more machine learning models. Each of the one or more machine learning models may be programmed to produce, for each training data set 714, at least one output intended to correspond to, or “predict,” a value of the at least one result data field of the training data set 714. “Machine learning” refers broadly to various algorithms that may be used to train the model to identify and recognize patterns in existing data in order to facilitate making predictions for subsequent new input data.

Model trainer module 718 may be configured to compare, for each training data set 714, the at least one output of the model to the at least one result data field of the training data set 714, and apply a machine learning algorithm to adjust parameters of the model in order to reduce the difference or “error” between the at least one output and the corresponding at least one result data field. In this way, model trainer module 718 trains the machine learning model to accurately predict the value of the at least one result data field.

In other words, model trainer module 718 cycles the one or more machine learning models through the training data sets 714, causing adjustments in the model parameters, until the error between the at least one output and the at least one result data field falls below a suitable threshold, and then uploads at least one trained machine learning model 716 to operational large language model module 706 for application to generating recommendations 720. In exemplary embodiments, model trainer module 718 may be configured to simultaneously train multiple candidate machine learning models and to select the best performing candidate for each result data field, as measured by the “error” between the at least one output and the corresponding result data field, to upload to operational predictive model module 706.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 718 cycles through the training data sets 714, model trainer module 718 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 718 may provide an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

The OAR server 610 of the present disclosure may be configured to operate on input data related to pricing models including to receive, review, and respond to inquiries from a regulation entity 105. In one exemplary embodiment, OAR server 610 executes the operational large language model module 702 programmed to learn, without limitation, outcomes of claims based upon varying events and details, relevant data sources for evidence, the queries used to prompt a user to provide relevant information, features of claims or evidence related to potential fraud, and the like.

To facilitate this learning, OAR server 610 may include one or more databases 702 at which the data, including data as well as responses, evidence, outcomes, etc., is stored. This data becomes one or more input training sets used by the training set builder 708. Model outputs can be formatted for presentation or review as visual representations of recommendations, as text-based or natural language recommendations, and the like. In exemplary embodiments, operational predictive model module 706 may compare feedback, and may route a comparison result 722 generated by comparing recommendation 720 to the feedback to a model updater module 724 of OAR server 610. Model updater module 724 is configured to derive a correction signal 726 from comparison results 722 received for one or more recommendations, and to provide correction signal 726 to model trainer module 718 to enable updating or “re-training” of the at least one machine learning model to improve performance. The retrained at least one machine learning model 716 may be periodically re-uploaded to operational predictive model module 706.

### Exemplary Client Device

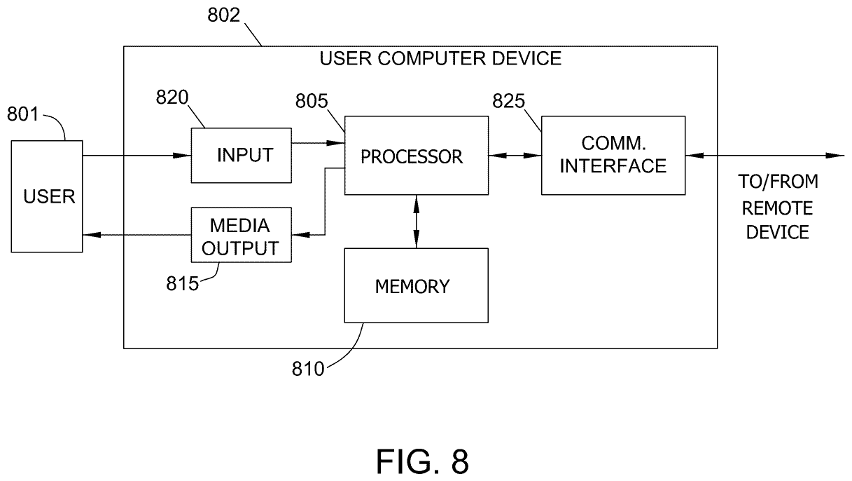

FIG. 8 depicts an exemplary configuration 800 of user computer device 802, in accordance with one embodiment of the present disclosure. In the exemplary embodiment, user computer device 802 may be similar to, or the same as, client device 605 (shown in FIG. 6). User computer device 802 may be operated by a user 801.

User computer device 802 may include a processor 805 for executing instructions. In some embodiments, executable instructions may be stored in a memory area 810. Processor 805 may include one or more processing units (e.g., in a multi-core configuration). Memory area 810 may be any device allowing information such as executable instructions and/or transaction data to be stored and retrieved. Memory area 810 may include one or more computer readable media.

User computer device 802 may also include at least one media output component 815 for presenting information to user 801. Media output component 515 may be any component capable of conveying information to user 801. In some embodiments, media output component 815 may include an output adapter (not shown) such as a video adapter and/or an audio adapter. An output adapter may be operatively coupled to processor 805 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 815 may be configured to present a graphical user interface (e.g., a web browser and/or a client application) to user 801. A graphical user interface may include, for example, an interface for viewing items of information provided by the OAR computer system 610 (shown in FIG. 6). In some embodiments, user computer device 802 may include an input device 820 for receiving input from user 801. User 801 may use input device 820 to, without limitation, provide information either through speech or typing.

Input device 820 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 815 and input device 820.

User computer device 802 may also include a communication interface 825, communicatively coupled to a remote device such as OAR computer system 610. Communication interface 825 may include, for example, a wired or wireless network adapter and/or a wireless data transceiver for use with a mobile telecommunications network.

Stored in memory area 810 are, for example, computer readable instructions for providing a user interface to user 801 via media output component 815 and, optionally, receiving and processing input from input device 820. A user interface may include, among other possibilities, a web browser and/or a client application. Web browsers enable users, such as user 801, to display and interact with media and other information typically embedded on a web page or a website from OAR computer system 610. A client application may allow user 801 to interact with, for example, OAR computer system 610. For example, instructions may be stored by a cloud service, and the output of the execution of the instructions sent to the media output component 815.

### Exemplary Server Device

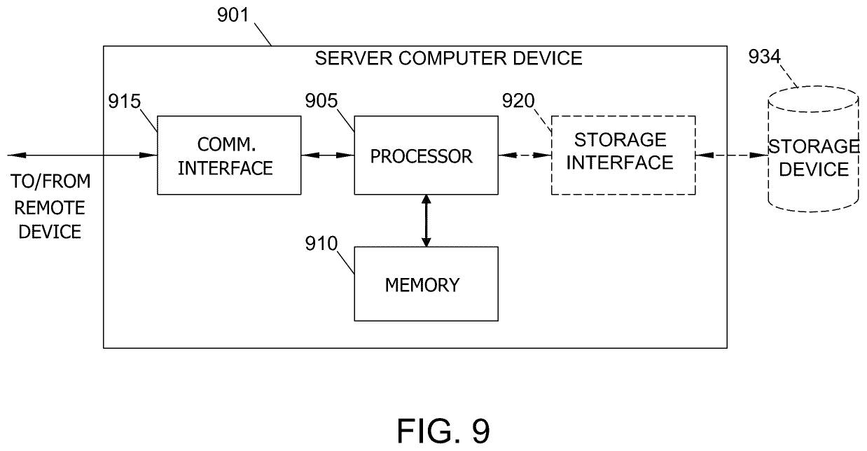

FIG. 9 depicts an exemplary configuration 900 of a server computer device 901, in accordance with one embodiment of the present disclosure. In the exemplary embodiment, server computer device 901 may be similar to, or the same as, OAR computer system 610 (shown in FIG. 6), database server 615, and third-party server 625 (both shown in FIG. 6). Server computer device 901 may also include a processor 905 for executing instructions. Instructions may be stored in a memory area 910. Processor 905 may include one or more processing units (e.g., in a multi-core configuration).

Processor 905 may be operatively coupled to a communication interface 915 such that server computer device 901 is capable of communicating with a remote device such as another server computer device 901, OAR computer system 610, third-party servers 625, and client devices 605 (shown in FIG. 6) (for example, using wireless communication or data transmission over one or more radio links or digital communication channels). For example, communication interface 915 may audio input from client devices 605 via the Internet, as illustrated in FIG. 6.

Processor 905 may also be operatively coupled to a storage device 934. Storage device 934 may be any computer-operated hardware suitable for storing and/or retrieving data, such as, but not limited to, data associated with one or more models. In some embodiments, storage device 934 may be integrated in server computer device 901. For example, server computer device 901 may include one or more hard disk drives as storage device 934.

In other embodiments, storage device 934 may be external to server computer device 901 and may be accessed by a plurality of server computer devices 901. For example, storage device 934 may include a storage area network (SAN), a network attached storage (NAS) system, and/or multiple storage units such as hard disks and/or solid-state disks in a redundant array of inexpensive disks (RAID) configuration.

In some embodiments, processor 905 may be operatively coupled to storage device 934 via a storage interface 920. Storage interface 920 may be any component capable of providing processor 905 with access to storage device 934. Storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 905 with access to storage device 934.

Processor 905 may execute computer-executable instructions for implementing aspects of the disclosure. In some embodiments, the processor 905 may be transformed into a special purpose microprocessor by executing computer-executable instructions or by otherwise being programmed. For example, the processor 905 may be programmed with the instruction such as illustrated in FIGS. 1-5.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, OAR computer system 610 is configured to implement machine learning, such that OAR computer system 610 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data. ML outputs may include, but are not limited to identified objects, items classifications, textual product, and/or other data extracted from the images or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with a plurality of text of a plurality of different questions, responses, objections, items, and/or information.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may utilize voice bots or chatbots configured to utilize artificial intelligence and/or machine learning techniques as described herein. For instance, the voice or chatbot may be a ChatGPT chatbot, and may be configured to help generate a response document as described herein. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### EXEMPLARY EMBODIMENTS

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) build the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers; (2) receive a current objection inquiry document for a rate change request from an insurance regulator, the current objection inquiry document including (i) at least one first objection to the rate change request and (ii) at least one first request for additional information; (3) electronically parse the current objection inquiry document to identify a first model input including text describing the at least one first objection and the at least one first request for additional information; (4) enter the first model input into the large language model to generate a first output including an electronic response document for responding to the current objection inquiry for the rate change request; and (5) transmit the electronic response document to the insurance regulator to respond to the at least one first objection and the at least one first request for additional information included in the current objection inquiry document. The system may include additional, less, or alternate functionality, including that discussed elsewhere herein.

An enhancement of the system may include a processor configured to receive a current decision document for the rate change request from the insurance regulator responding to the electronic response document, the current decision document including (i) at least one second objection to the rate change request and (ii) at least one second request for additional information. The system may also include a processor configured to electronically parse the current decision document to identify a second model input including text describing the at least one second objection and the at least one second request for additional information. The system may further include a processor configure to enter the second model input and the first model input into the large language model to generate a second output including a second electronic response document for responding to the current decision document for the rate change request. Additionally, the system may include a processor configured to transmit the second electronic response document to the insurance regulator to respond to the at least one second objection and the at least one second request for additional information included in the current decision document.

A further enhancement of the system may include where the at least one second objection to the rate change request is (i) different from the first objection to the rate change request, (ii) the same as the first objection to the rate change request, or (iii) a combination of a new objection and a renewal of the first objection to the rate change request.

A further enhancement of the system may include where the at least one second request for additional information for the rate change request is (i) different from the first request for additional information for the rate change request, (ii) the same as the first request for additional information for the rate change request, or (iii) a combination of a new request for additional information and a renewal of the first request for additional information for the rate change request.

A further enhancement of the system may include where the at least one processor is further programmed to apply the large language model including a generative AI large language model configured to generate complete electronic response documents responding to objections and/or requests for additional information from insurance regulators.

A further enhancement of the system may include a processor configured to build the large language model including a generative AI large language model configured to use a retrieval augmented generation (RAG) system to generate the electronic response document or the second electronic response document.

An further enhancement of the system may include a processor configured to build and train the large language model by inputting: (i) a plurality of historical rate change requests from a plurality of insurance providers, (ii) a plurality of historical objection inquiries each being associated with at least one of the plurality of rate change requests, (iii) a plurality of historical responses from the insurance providers to the plurality of historical objection inquiries, and (iv) a plurality of historical decisions from the insurance regulators responding to the plurality of historical responses from the insurance providers including whether the historical responses were successful in getting the corresponding rate change request approved by the insurance regulators.

A further enhancement of the system may include a processor configured to electronically parse the current objection inquiry document by using Natural Language Processing (NLP) tools to identify a first objection included in the current objection inquiry document. The further enhancement may also include a processor configured to using the NLP tools, identify key words describing the first objection. The further enhancement may further include a processor configured to generate a first query using the key words. Additionally, the further enhancement may include a processor configured to apply the first query to the large language model to output a first portion of text that responds to the first objection, wherein the first portion of text includes electronic text and/or graphics that completely respond to the first objection.

A further enhancement of the system may include a processor configured to electronically parse the current objection inquiry document by using Natural Language Processing (NLP) tools to identify a first request for information included in the current objection inquiry document. The further enhancement may also include a processor configured to using the NLP tools, identify key words describing the first request for information. The further enhancement may further include a processor configured to generate a second query using the key words describing the first request for information. Additionally, the further enhancement may include a processor configured to apply the second query to the large language model to output a second portion of text that responds to the first request for information, wherein the second portion of text includes electronic text and/or graphics that completely respond to the first request for information.

A further enhancement of the system may include a processor configured to apply the first query and the second query to the large language model to output a transitional portion of text for transitioning between the first portion and the second portion, wherein the transitional portion of text includes electronic text and/or graphics.

A further enhancement of the system may include a processor configured to apply the first query and the second query to the large language model to output a response header including text indicating a party who the electronic response document is to be addressed to, a date the electronic response document is to be sent, and a due date for submitting the electronic response document.

A further enhancement of the system may include a processor configured to generate the first output including the electronic response document by combining the response header, the first portion, the second portion and the transitional portion.

A further enhancement of the system may include a processor configured to electronically parse the current decision document by using Natural Language Processing (NLP) tools to identify a first objection included in the current decision document. The further enhancement may also include a processor configured to using the NLP tools, identify key words describing the first objection in the decision document. The further enhancement may further include a processor configured to generate a first query for the decision document using the key words. Additionally, the further enhancement may include a processor configured to apply the first query for the decision document to the large language model to output a third portion of text that responds to the first objection of the decision document, wherein the third portion of text includes electronic text and/or graphics that completely respond to the first objection of the decision document.

A further enhancement of the system may include a processor configured to electronically parse the current decision document by using Natural Language Processing (NLP) tools to identify a first request for information included in the current decision document. The further enhancement may also include a processor configured to using the NLP tools, identify key words describing the first request for information in the decision document. The further enhancement may further include a processor configured to generate a second query for the decision document using the key words describing the first request for information. Additionally, the further enhancement may include a processor configured to apply the second query to the large language model to output a fourth portion of text that responds to the first request for information in the decision document, wherein the fourth portion of text includes electronic text and/or graphics that completely respond to the first request for information.

A further enhancement of the system may include a processor configured to apply the first query and the second query of the decision document to the large language model to output a transitional portion of text for transitioning between the third portion and the fourth portion, wherein the transitional portion of text includes electronic text and/or graphics.

A further enhancement of the system may include a processor configured to apply the first query and the second query of the decision document to the large language model to output a response header including text indicating a party who the second electronic response document is to be addressed to, a date the second electronic response document is to be sent, and a due date for submitting the second electronic response document.

A further enhancement of the system may include a processor configured to generate the second output including the second electronic response document by combining the response header, the third portion, the fourth portion and the transitional portion of the decision document.

A further enhancement of the system may include a processor configured to automatically track progress of an initial rate change request submitted by the insurance provider; the objection inquiry document issued by the insurance regulator; the electronic response document submitted in response to the objection inquiry document; the decision document issued by the insurance regulator in response to the electronic response document, and the second electronic document submitted by the insurance provider in response to the decision document.

A further enhancement of the system may include a processor configured to cause progress of each document to be displayed on a dashboard for a user to track and follow up as needed.

In another aspect, a computer-implemented method may be provided. The computer-implemented method may be performed by a computer device including at least one processor in communication with at least one memory device. The method may include: (1) building the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers; (2) receiving a current objection inquiry document for a rate change request from an insurance regulator, the current objection inquiry document including (i) at least one first objection to the rate change request and (ii) at least one first request for additional information; (3) electronically parsing the current objection inquiry document to identify a first model input including text describing the at least one first objection and the at least one first request for additional information; (4) entering the first model input into the large language model to generate a first output including an electronic response document for responding to the current objection inquiry for the rate change request; and (5) transmitting the electronic response document to the insurance regulator to respond to the at least one first objection and the at least one first request for additional information included in the current objection inquiry document. The computer-implemented method may include additional, less, or alternate actions, including those discussed elsewhere herein.

An enhancement of the method may include receiving a current decision document for the rate change request from the insurance regulator responding to the electronic response document, the current decision document including (i) at least one second objection to the rate change request and (ii) at least one second request for additional information. The enhancement may also include electronically parsing the current decision document to identify a second model input including text describing the at least one second objection and the at least one second request for additional information. The enhancement may further include entering the second model input and the first model input into the large language model to generate a second output including a second electronic response document for responding to the current decision document for the rate change request. Additionally, the method may include transmitting the second electronic response document to the insurance regulator to respond to the at least one second objection and the at least one second request for additional information included in the current decision document.

A further enhancement of the method may include where the at least one second objection to the rate change request is (i) different from the first objection to the rate change request, (ii) the same as the first objection to the rate change request, or (iii) a combination of a new objection and a renewal of the first objection to the rate change request.

A further enhancement of the method may include where the at least one second request for additional information for the rate change request is (i) different from the first request for additional information for the rate change request, (ii) the same as the first request for additional information for the rate change request, or (iii) a combination of a new request for additional information and a renewal of the first request for additional information for the rate change request.

A further enhancement of the method may include applying the large language model including a generative AI large language model configured to generate complete electronic response documents responding to objections and/or requests for additional information from insurance regulators.

A further enhancement of the method may include building the large language model including a generative AI large language model configured to use a retrieval augmented generation (RAG) system to generate the electronic response document or the second electronic response document.

A further enhancement of the method may include building and training the large language model by inputting: (i) a plurality of historical rate change requests from a plurality of insurance providers, (ii) a plurality of historical objection inquiries each being associated with at least one of the plurality of rate change requests, (iii) a plurality of historical responses from the insurance providers to the plurality of historical objection inquiries, and (iv) a plurality of historical decisions from the insurance regulators responding to the plurality of historical responses from the insurance providers including whether the historical responses were successful in getting the corresponding rate change request approved by the insurance regulators.

A further enhancement of the method may include electronically parsing the current objection inquiry document by using Natural Language Processing (NLP) tools to identify a first objection included in the current objection inquiry document. The further enhancement of the method may also include using the NLP tools, identifying key words describing the first objection. The further enhancement of the method may further include generating a first query using the key words. Additionally, the further enhancement of the method may include applying the first query to the large language model to output a first portion of text that responds to the first objection, wherein the first portion of text includes electronic text and/or graphics that completely respond to the first objection.

A further enhancement of the method may include electronically parsing the current objection inquiry document by using Natural Language Processing (NLP) tools to identify a first request for information included in the current objection inquiry document. The further enhancement of the method may also include using the NLP tools, identifying key words describing the first request for information. The further enhancement of the method may further include generating a second query using the key words describing the first request for information. Additionally, further enhancement of the method may include applying the second query to the large language model to output a second portion of text that responds to the first request for information, wherein the second portion of text includes electronic text and/or graphics that completely respond to the first request for information.

A further enhancement of the method may include applying the first query and the second query to the large language model to output a transitional portion of text for transitioning between the first portion and the second portion, wherein the transitional portion of text includes electronic text and/or graphics.

A further enhancement of the method may include applying the first query and the second query to the large language model to output a response header including text indicating a party who the electronic response document is to be addressed to, a date the electronic response document is to be sent, and a due date for submitting the electronic response document.

A further enhancement of the method may include generating the first output including the electronic response document by combining the response header, the first portion, the second portion and the transitional portion.

A further enhancement of the method may include electronically parsing the current decision document by using Natural Language Processing (NLP) tools to identify a first objection included in the current decision document. The further enhancement of the method may also include using the NLP tools, identifying key words describing the first objection in the decision document. The further enhancement of the method may further include generating a first query for the decision document using the key words. Additionally, the further enhancement of the method may include applying the first query for the decision document to the large language model to output a third portion of text that responds to the first objection of the decision document, wherein the third portion of text includes electronic text and/or graphics that completely respond to the first objection of the decision document.

A further enhancement of the method may include electronically parsing the current decision document by using Natural Language Processing (NLP) tools to identify a first request for information included in the current decision document. The further enhancement of the method may also include using the NLP tools, identifying key words describing the first request for information in the decision document. The further enhancement of the method may further include generating a second query for the decision document using the key words describing the first request for information. Additionally, the further enhancement of the method may include applying the second query to the large language model to output a fourth portion of text that responds to the first request for information in the decision document, wherein the fourth portion of text includes electronic text and/or graphics that completely respond to the first request for information.

A further enhancement of the method may include applying the first query and the second query of the decision document to the large language model to output a transitional portion of text for transitioning between the third portion and the fourth portion, wherein the transitional portion of text includes electronic text and/or graphics.

A further enhancement of the method may include applying the first query and the second query of the decision document to the large language model to output a response header including text indicating a party who the second electronic response document is to be addressed to, a date the second electronic response document is to be sent, and a due date for submitting the second electronic response document.

A further enhancement of the method may include generating the second output including the second electronic response document by combining the response header, the third portion, the fourth portion and the transitional portion of the decision document.

A further enhancement of the method may include automatically tracking progress of an initial rate change request submitted by the insurance provider; the objection inquiry document issued by the insurance regulator; the electronic response document submitted in response to the objection inquiry document; the decision document issued by the insurance regulator in response to the electronic response document, and the second electronic document submitted by the insurance provider in response to the decision document.

A further enhancement of the method may include causing progress of each document to be displayed on a dashboard for a user to track and follow up as needed.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) build the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers; (2) receive a current objection inquiry document for a rate change request from an insurance regulator, the current objection inquiry document including (i) at least one first objection to the rate change request and (ii) at least one first request for additional information; (3) electronically parse the current objection inquiry document to identify a first model input including text describing the at least one first objection and the at least one first request for additional information; (4) enter the first model input into the large language model to generate a first output including an electronic response document for responding to the current objection inquiry for the rate change request; and (5) transmit the electronic response document to the insurance regulator to respond to the at least one first objection and the at least one first request for additional information included in the current objection inquiry document. The computer-executable instructions may direct additional, less, or alternate functionality, including that discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, NoSQL, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for generating a response to a current objection inquiry document using artificial intelligence (AI) tools, the computer system comprising:
at least one processor;
at least one memory device in communication with the at least one processor, and
AI tools including a large language model, wherein the at least one processor is programmed to:
build the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers;
receive a current objection inquiry document for a rate change request from an insurance regulator, the current objection inquiry document including (i) at least one first objection to the rate change request and (ii) at least one first request for additional information;
electronically parse the current objection inquiry document to identify a first model input including text describing the at least one first objection and the at least one first request for additional information;
enter the first model input into the large language model to generate a first output including an electronic response document for responding to the current objection inquiry for the rate change request; and
transmit the electronic response document to the insurance regulator to respond to the at least one first objection and the at least one first request for additional information included in the current objection inquiry document.

2. The computer system of claim 1, wherein the at least one processor is further programmed to:
receive a current decision document for the rate change request from the insurance regulator responding to the electronic response document, the current decision document including (i) at least one second objection to the rate change request and (ii) at least one second request for additional information;
electronically parse the current decision document to identify a second model input including text describing the at least one second objection and the at least one second request for additional information;
enter the second model input and the first model input into the large language model to generate a second output including a second electronic response document for responding to the current decision document for the rate change request; and
transmit the second electronic response document to the insurance regulator to respond to the at least one second objection and the at least one second request for additional information included in the current decision document.

3. The computer system of claim 2, wherein the at least one second objection to the rate change request is (i) different from the first objection to the rate change request, (ii) the same as the first objection to the rate change request, or (iii) a combination of a new objection and a renewal of the first objection to the rate change request.

4. The computer system of claim 2, wherein the at least one second request for additional information for the rate change request is (i) different from the first request for additional information for the rate change request, (ii) the same as the first request for additional information for the rate change request, or (iii) a combination of a new request for additional information and a renewal of the first request for additional information for the rate change request.

5. The computer system of claim 2, wherein the at least one processor is further programmed to build the large language model including a generative AI large language model configured to use a retrieval augmented generation (RAG) system to generate the electronic response document or the second electronic response document.

6. The computer system of claim 1, wherein the at least one processor is further programmed to apply the large language model including a generative AI large language model configured to generate complete electronic response documents responding to objections and/or requests for additional information from insurance regulators.

7. The computer system of claim 1, wherein the at least one processor is further programmed to build and train the large language model by inputting: (i) a plurality of historical rate change requests from a plurality of insurance providers, (ii) a plurality of historical objection inquiries each being associated with at least one of the plurality of rate change requests, (iii) a plurality of historical responses from the insurance providers to the plurality of historical objection inquiries, and (iv) a plurality of historical decisions from the insurance regulators responding to the plurality of historical responses from the insurance providers including whether the historical responses were successful in getting the corresponding rate change request approved by the insurance regulators.

8. The computer system of claim 1, wherein the at least one processor is further programmed to:
electronically parse the current objection inquiry document by using Natural Language Processing (NLP) tools to identify a first objection included in the current objection inquiry document;
using the NLP tools, identify key words describing the first objection;
generate a first query using the key words; and
apply the first query to the large language model to output a first portion of text that responds to the first objection, wherein the first portion of text includes electronic text and/or graphics that completely respond to the first objection.

9. The computer system of claim 8, wherein the at least one processor is further programmed to:
electronically parse the current objection inquiry document by using Natural Language Processing (NLP) tools to identify a first request for information included in the current objection inquiry document;
using the NLP tools, identify key words describing the first request for information;
generate a second query using the key words describing the first request for information; and
apply the second query to the large language model to output a second portion of text that responds to the first request for information, wherein the second portion of text includes electronic text and/or graphics that completely respond to the first request for information.

10. The computer system of claim 9, wherein the at least one processor is further programmed to apply the first query and the second query to the large language model to output a transitional portion of text for transitioning between the first portion and the second portion, wherein the transitional portion of text includes electronic text and/or graphics.

11. The computer system of claim 10, wherein the at least one processor is further programmed to apply the first query and the second query to the large language model to output a response header including text indicating a party who the electronic response document is to be addressed to, a date the electronic response document is to be sent, and a due date for submitting the electronic response document.

12. The computer system of claim 11, wherein the at least one processor is further programmed to generate the first output including the electronic response document by combining the response header, the first portion, the second portion and the transitional portion.

13. The computer system of claim 2, wherein the at least one processor is further programmed to:
electronically parse the current decision document by using Natural Language Processing (NLP) tools to identify a first objection included in the current decision document;
using the NLP tools, identify key words describing the first objection in the decision document;
generate a first query for the decision document using the key words; and
apply the first query for the decision document to the large language model to output a third portion of text that responds to the first objection of the decision document, wherein the third portion of text includes electronic text and/or graphics that completely respond to the first objection of the decision document.

14. The computer system of claim 13, wherein the at least one processor is further programmed to:
electronically parse the current decision document by using Natural Language Processing (NLP) tools to identify a first request for information included in the current decision document;
using the NLP tools, identify key words describing the first request for information in the decision document;
generate a second query for the decision document using the key words describing the first request for information; and
apply the second query to the large language model to output a fourth portion of text that responds to the first request for information in the decision document, wherein the fourth portion of text includes electronic text and/or graphics that completely respond to the first request for information.

15. The computer system of claim 14, wherein the at least one processor is further programmed to apply the first query and the second query of the decision document to the large language model to output a transitional portion of text for transitioning between the third portion and the fourth portion, wherein the transitional portion of text includes electronic text and/or graphics.

16. The computer system of claim 15, wherein the at least one processor is further programmed to apply the first query and the second query of the decision document to the large language model to output a response header including text indicating a party who the second electronic response document is to be addressed to, a date the second electronic response document is to be sent, and a due date for submitting the second electronic response document.

17. The computer system of claim 16, wherein the at least one processor is further programmed to generate the second output including the second electronic response document by combining the response header, the third portion, the fourth portion and the transitional portion of the decision document.

18. The computer system of claim 2, wherein the at least one processor is further programmed to automatically track progress of an initial rate change request submitted by the insurance provider, the objection inquiry document issued by the insurance regulator, the electronic response document submitted in response to the objection inquiry document, the decision document issued by the insurance regulator in response to the electronic response document, and the second electronic response document submitted by the insurance provider in response to the decision document.

19. The computer system of claim 18, wherein the at least one processor is further programmed to:
cause progress of each document to be displayed on a dashboard for a user to track and follow up as needed.

20. A computer-implemented method implemented by a computer system including at least one processor in communication with at least one memory device and artificial intelligence (AI) tools including a large language model, the method comprises:
building the large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers;
receiving a current objection inquiry document for a rate change request from an insurance regulator, the current objection inquiry document including (i) at least one first objection to the rate change request and (ii) at least one first request for additional information;
electronically parsing the current objection inquiry document to identify a first model input including text describing the at least one first objection and the at least one first request for additional information;
entering the first model input into the large language model to generate a first output including an electronic response document for responding to the current objection inquiry for the rate change request; and
transmitting the electronic response document to the insurance regulator to respond to the at least one first objection and the at least one first request for additional information included in the current objection inquiry document.

21. At least one non-transitory computer-readable storage media having computer-executable instructions embodied thereon, wherein when executed by at least one processor of a computer system, the computer-executable instructions cause the processor to:
build a large language model for insurance rate change requests using at least the following input documents: (i) a plurality of historical rate change requests from an insurance provider including a description of each historical rate change request, (ii) a plurality of historical objection inquiries from insurance regulators to the plurality of historical rate change requests including one or more different objections and/or requests for information relating to each of the historical rate change requests, (iii) a plurality of historical responses from the insurance providers to the plurality of historical objection inquiries including responses to each of the one or more objections and/or requests for information, and (iv) a plurality of historical decisions from the insurance regulators responding to the plurality of historical responses from the insurance providers;
receive a current objection inquiry document for a rate change request from an insurance regulator, the current objection inquiry document including (i) at least one first objection to the rate change request and (ii) at least one first request for additional information;
electronically parse the current objection inquiry document to identify a first model input including text describing the at least one first objection and the at least one first request for additional information;
enter the first model input into the large language model to generate a first output including an electronic response document for responding to the current objection inquiry for the rate change request; and
transmit the electronic response document to the insurance regulator to respond to the at least one first objection and the at least one first request for additional information included in the current objection inquiry document.
